(19) United States
(12) Patent Application Publication
(10) Pub. No.: US 2014/0368432 A1
(43) Pub. Date: Dec. 18, 2014

(54) WEARABLE SMART GLASSES AS WELL AS DEVICE AND METHOD FOR CONTROLLING THE SAME

(71) Applicant: TENCENT TECHNOLOGY (SHENZHEN) COMPANY LIMITED, Shenzhen City (CN)

(72) Inventor: JIN-MING ZHANG, Shenzhen City (CN)

(73) Assignee: TENCENT TECHNOLOGY (SHENZHEN) COMPANY LIMITED, Shenzhen City (CN)

(21) Appl. No.: 14/254,888

(22) Filed: Apr. 16, 2014

Related U.S. Application Data
(63) Continuation of application No. PCT/CN2013/090111, filed on Dec. 20, 2013.

(30) Foreign Application Priority Data
Jun. 17, 2013 (CN) 201310239041.1

(51) Int. Cl. G06F 3/01

(52) U.S. Cl. CPC G06F 3/013
USPC 345/158

(57) ABSTRACT

A method for controlling a wearable smart glasses is provided, wherein the method comprises steps as follows: a gaze point over an operation system interface of the wearable smart glasses on which a user's eyeballs focus is determined and traced. A controlling command provided by the user through a touch switch module of the wearable smart glasses is received. A corresponding process is then performed on the gaze point according to the controlling command.

### CROSS-REFERENCE TO RELATED APPLICATION

This application is a continuation application of International (PCT) Patent Application No. PCT/CN2013/090111, filed on Dec. 20, 2013, now pending and designating the United States, which also claims benefit of China Patent Application No. 201310239041.1, filed on Jun. 17, 2013. The entirety of the above-mentioned patent applications is hereby incorporated by reference herein and made a part of this specification.

### FIELD OF THE INVENTION

The present invention relates to wearable technology and more particularly to a wearable smart glasses as well as a device and a method for controlling the same.

### BACKGROUND OF THE INVENTION

Along with the development of intellectual technology a wearable smart glasses is provided. The so-called wearable smart glasses, also referred as to a smart glasses, is a wearable glasses that can function as a smart phone having an independent operation system used either to access software, such as games or application programs provided by web service providers, to maintain a calendar, to implement a map navigation, to communicate with friends by a video call, to take pictures or record videos or to share the pictures and videos with friends through mobile or wireless communication. Currently, a wearable smart glasses is typically operated by the user's audio controlling commands. While the user wants the wearable smart glasses to perform an operation, an audio controlling command with clear articulation and a mellow and full tone may be required in English or other language. However, since the audio frequency of the audio controlling command may be interfered by ambient noise and a clearly and loudly pronounced audio controlling command may disturb other people in a public place, thus an audio controlling command with clear articulation and a mellow and full tone may not be received by the wearable smart glasses in the aforementioned contexts. As a result, it is hard to communicate the wearable smart glasses to perform a desired operation under these circumstances.

Therefore, how to improve the operation reliability and efficiency of a wearable smart glasses is still a challenge to the art.

### SUMMARY OF THE INVENTION

Accordingly a wearable smart glasses as well as a device and a method for controlling the same are provided.

In accordance with an aspect of the present invention a method for controlling a wearable smart glasses is provided, wherein the method comprises steps as follows: A gaze point over an operation system interface of the wearable smart glasses on which a user's eyeballs focus is determined and traced. A controlling command provided by the user through a touch switch module of the wearable smart glasses is received. A corresponding process is then performed on the gaze point according to the controlling command.

In accordance with another aspect, an device for controlling a wearable smart glasses is provided, wherein the device comprises a gaze point tracing module used to determine and trace a gaze point over an operation system interface of the wearable smart glasses on which a user's eyeballs focus, a controlling command receiving module used to receive a controlling command provided by the user through a touch switch module, and a controlling command implementing module used to perform a corresponding process at the gaze point according to the controlling command.

In accordance with yet another aspect, the wearable smart glasses is provided wherein the wearable smart glasses comprises a frame, a photographic module used to determine and trace a gaze point over an operation system interface of the wearable smart glasses on which a user's eyeballs focus, a touch switch module disposed on the frame and used to receive a controlling command converted from a user's touch gesture, and a central processing unit (CPU) used to perform a corresponding process on the gaze point according to the controlling command.

In accordance with the aforementioned embodiments, a wearable smart glasses as well as the device and the method for controlling the same are provided, wherein a controlling command of a user provided trough a touch switch module of the wearable smart glasses is received, and a corresponding process is then performed at a gaze point gaze point on which the user's eyeballs focus over an operation system interface of the wearable smart glasses, whereby the wearable smart glasses can be well operated by a user's touch gesture, even if the wearable smart glasses is operated in a context that an audio controlling command with clear articulation and a mellow and full tone is not available. As a result, the operation efficiency and reliability of the wearable smart glasses disclosed by the embodiments of the present invention can be significantly improved.

The above objects and advantages of the present invention will become more readily apparent to those ordinarily skilled in the art after reviewing the following detailed descriptions and accompanying drawings:

### BRIEF DESCRIPTION OF THE DRAWINGS

FIG. 1 is a block diagram illustrating a method for controlling a wearable smart glasses, in accordance with a first embodiment of the present invention;

FIGS. 2A-2C are jointly a block diagram illustrating a method for controlling a wearable smart glasses, in accordance with a second embodiment of the present invention;

FIG. 3 is a block diagram illustrating a device for controlling a wearable smart glasses, in accordance with a third embodiment of the present invention;

FIG. 4 is a block diagram illustrating a device for controlling a wearable smart glasses, in accordance with a fourth embodiment of the present invention; and

FIG. 5 is a diagram illustrating a wearable smart glasses, in accordance with a fifth embodiment of the present invention.

### DETAILED DESCRIPTION OF PREFERRED EMBODIMENTS

The present invention will now be described more specifically with reference to the following embodiments and accompanying drawings. It is to be noted that the following descriptions of preferred embodiments of this invention are presented herein for the purpose of illustration and description only. It is not intended to be exhaustive or to be limited to the precise form disclosed.

In accordance with an aspect of the present invention a method for controlling a wearable smart glasses is provided to perform a corresponding process over an operation system interface of the wearable smart glasses according to the controlling command received from a user.

### First Embodiment

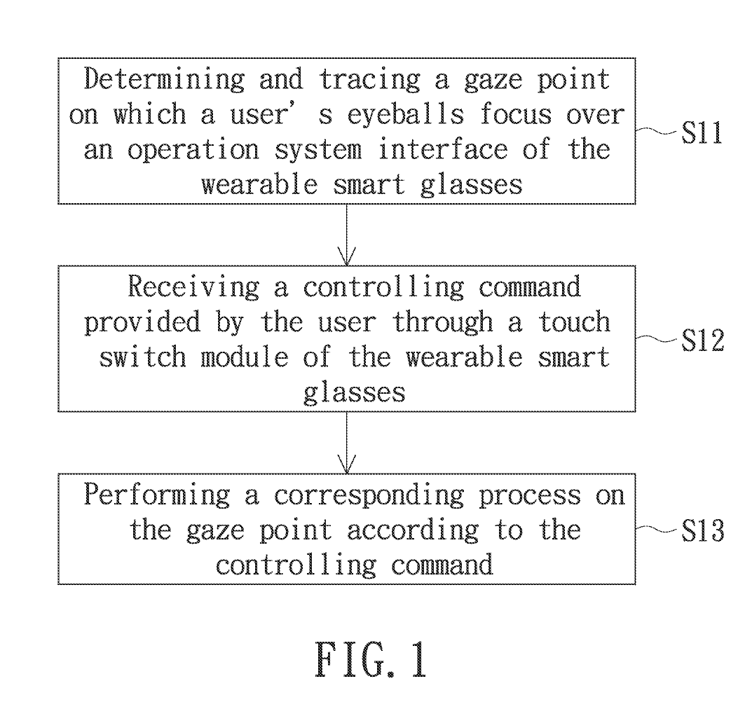

FIG. 1 is a block diagram illustrating a method for controlling a wearable smart glasses, in accordance with a first embodiment of the present invention, wherein the method for controlling a wearable smart glasses comprises steps as follows:

A gaze point on which a user's eyeballs focus is determined and traced over an operation system interface of the wearable smart glasses (see Step S11).

In some embodiments of the present invention, the operation system interface of the wearable smart glasses is a graphical user interface that is displayed on the lenses of the wearable smart glasses and is visible to the user's eyes while he or she wears the wearable smart glasses. In the present embodiment, the graphical user interface is projected in the user's filed of vision, i.e. an area that is right across from the user's eyeballs about 10 centimeter (cm).

In some embodiments of the present invention, the wearable smart glasses further comprises a photographer used to trace either the point of gaze or the motion of the user's eyeball. The orbit of the gaze point or the eye motion is then associated with coordinates build in the graphical user interface, thus a focus position data comprising information about a gaze point on which a user's eyeballs focus over an operation system interface of the wearable smart glasses at a certain moment can be obtained. In the present embodiment, the focus position data at least comprises the coordinates of the operation system interface that corresponds to the gaze point on which the user's eyeballs focus over the operation system interface. For example, if the operation system interface has a resolution of 1204×768, and the coordinates can be established by using the upper left corner of the operation system interface as the base point. While the point of gaze of the user's eyeballs focus on the upper left corner of the operation system interface, the corresponding coordinate can be referred as to (0,0); otherwise while the point of gaze of the user's eyeballs focus on the lower right corner of the operation system interface, the corresponding coordinate can be referred as to (1204,7680), and the rest coordinates of the corresponding gaze points may be deduced by analogy. Since the process of measuring either the point of gaze (where one is looking) or the motion of eyeballs are well known, and thus the detail step and mechanism thereof will not be redundantly described herein.

A controlling command provided by the user through a touch switch module of the wearable smart glasses is received (see Step S12).

In practice, the touch switch module that is disposed on a touch panel set on a surface of the frame is used to detect a user's touch gesture, and to convert the received user's touch gesture into a controlling command according to a predetermined rule. For example, a touch on the touch panel for a predetermined continue period of time may be detected and converted into a controlling command of “turn on the operation system interference” by the touch switch module; and several continuous touches on the touch panel within 0.2 second may be detected and converted into another controlling command of “turn off the operation system interference”. In some embodiments of the present invention, the touch panel may be a surface capacitive touch panel, a resistive touch panel, a surface acoustic wave touch panel, infrared touch panel or a projected capacitive touch panel. Alternatively, in some other embodiment, the touch switch module may be a control button set on the frame of the wearable smart glasses or an external device, such as a control wire, used to receive the user's commands.

Subsequently, a corresponding process is then performed on the gaze point according to the controlling command (see Step S13).

In some embodiments of the present invention, the corresponding process may be either a process for turning on/off an applying program performed at the gaze point, a process for either selecting, cutting copying or pasting text message that is originally displayed or desired to be displayed on the gaze point, process for performing a quick bar, or any other process that would be performed by a mouse under the current and future technology.

From the forgoing, by implementing the method for controlling the wearable smart glasses of the present embodiment, a corresponding process can be performed at the gaze point on which the user's eyeballs focus over the operation system interface according to the user's controlling command provided through a touch switch module of the wearable smart glasses, thereby the wearable smart glasses can be well operated by a user's touch gesture, even if the wearable smart glasses is operated in a context that an audio controlling command with clear articulation and a mellow and full tone is not available. As a result, the operation reliability and efficiency of the wearable smart glasses can be improved significantly, so as to provide more convenience to the user.

### Second Embodiment

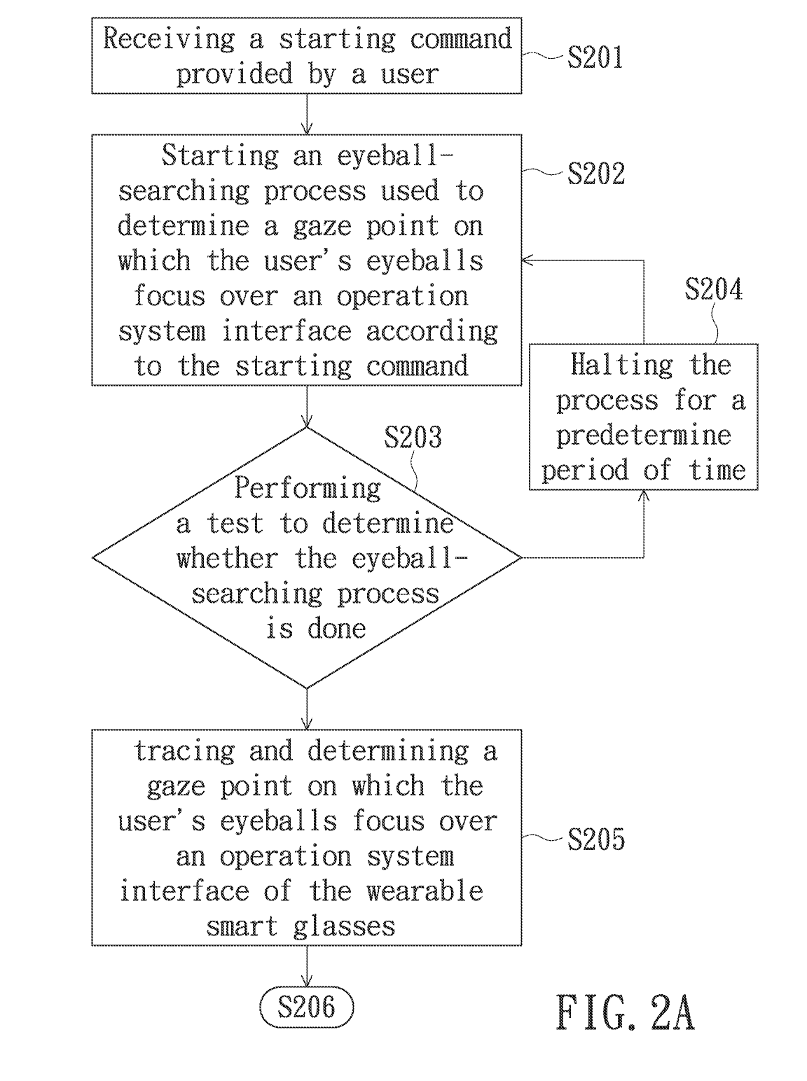

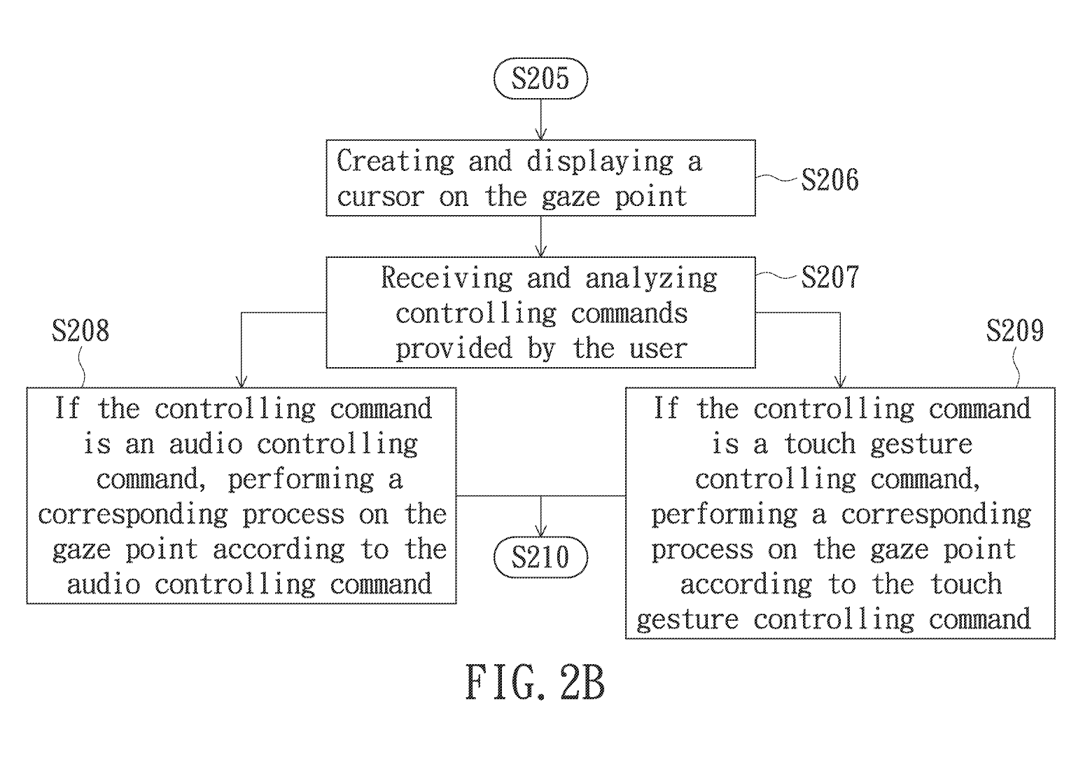

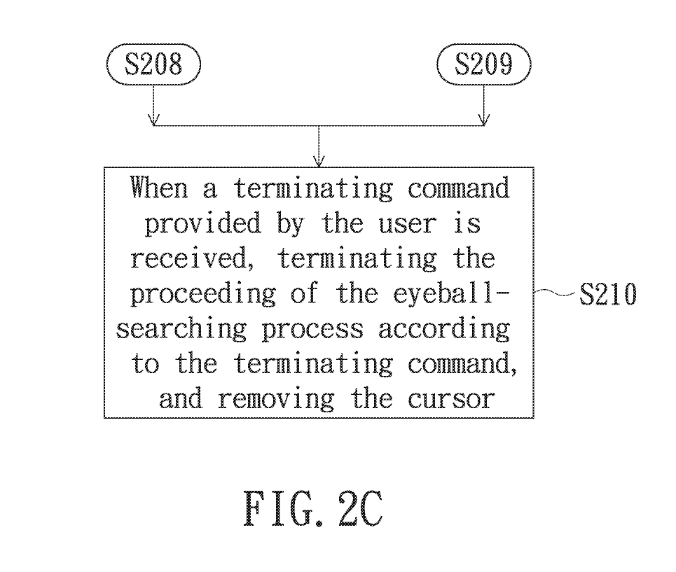

FIGS. 2A to 2C are jointly a block diagram illustrating a method for controlling a wearable smart glasses, in accordance with a second embodiment of the present invention, wherein the method for controlling a wearable smart glasses comprises steps as follows:

Firstly a starting command provided by a user is received (see Step S201).

In practice, the starting command provided by the user can be received from a start switch disposed on the wearable smart glasses. It should be appreciated that the start switch may be otherwise disposed on any position of the wearable smart glasses. For example, the start switch may be disposed on a frame of the wearable smart glasses. In another embodiment of the present invention, the starting command provided by the user is preferably received from a start switch disposed on a touch panel of the wearable smart glasses, when a touch of the user on the touch panel for 10 seconds is detected, for example, the starting command can be received. However, in yet another embodiment of the present invention, the starting command provided by the user is preferably received from an external device, such as a control wire connected to the wearable smart glasses.

Next, an eyeball-searching process used to determine a gaze point on which the user's eyeballs focus over an operation system interface is started according to the starting command (see Step S202).

In practice, when the starting command provided by the user is received, the eyeball-searching process is started to determine a gaze point on which the user's eyeballs focus over an operation system interface of the wearable smart glasses by using a photographer to detect whether there exists any object close up to the lenses of the wearable smart glasses. Image of the object, if any, is then taken by the photographer to determine whether this object is an eyeball. The criteria of “close up to the lenses” may be defined as that the distance between object and the lenses is shorter than the distance measured from the eyeball to the surface of the lenses opposite to the eyeball when the user usually wears the wearable smart glasses.

A test is then performed to determine whether the eyeball-searching process is done (see Step S203).

If the answer is “No”, proceed to Step S204: the Step S202 for searching eyeballs is performed again after the process is halted for a predetermine period of time.

If the answer is “Yes”, proceed to Step S205: a gaze point on which the user's eyeballs focus over an operation system interface of the wearable smart glasses is then traced and determined.

Since the process of Step S205 for tracing and determining the gaze point is similar than that described in the first embodiment, and thus the detail mechanism thereof will not be redundantly described herein.

Subsequently, a cursor is created and displayed on the gaze point (see Step S206).

The cursor informs the user the position of the gaze point on which his or her eyeballs focus being over an operation system interface of the wearable smart. In practice, the user's gaze point on which his or her eyeballs focus over an operation system interface of the wearable smart glasses can be traced and determined just in time, and the cursor is simultaneously created to indicate the position of the gaze point over the operation system interface. From the user's perspective, the motion of the user's eyeball and the cursor movement may be taken placed simultaneously, and thus the user can select the target that he or she wants to control over the operation system interface of the wearable smart glasses more accurately by moving his or her eyeball. As a result, the operating reliability of the wearable smart glasses can be also improved significantly.

Controlling commands provided by the user are received and analyzed (see Step S207).

It should be appreciated that the proceeding of the eyeball-searching process used to determine a gaze point on which the user's eyeballs focus over an operation system interface does not interfere in any controlling process that is performed according to one of the controlling commands, such as an audio controlling command, provided by the user. In some embodiments, the controlling commands preferably may be either a singular audio controlling command provided by voice input, a singular touch gesture controlling command resulted from the user's touch gesture detected and converted by a touch switch module of the wearable smart glasses, or the combination of the audio controlling command and the touch gesture controlling command.

If the controlling command is an audio controlling command, a corresponding process is then performed on the gaze point according to the audio controlling command (see Step S208).

If the controlling command is a touch gesture controlling command, a corresponding process is then performed on the gaze point according to the touch gesture controlling command (see Step S209).

It should be appreciated that the operation types of the audio controlling command and the touch gesture controlling command may be either different or identical. When there are several controlling commands are received, these controlling commands may be analyzed in sequence according to the order when the controlling commands are received to determine the operation types thereof; and the corresponding processes of these controlling commands are performed on the gaze point according to the same order.

When a terminating command provided by the user is received, the proceeding of the eyeball-searching process used to determine a gaze point on which the user's eyeballs focus over an operation system interface is terminated according to the terminating command, and the cursor is then removed (see Step S210).

Since the process for receiving the terminating command is similar to that for receiving the starting command set forth in the detail description of Step S201, e.g. receiving the terminating command through a switch disposed on the wearable smart glasses, and thus the detail step and mechanism thereof will not be redundantly described herein.

In addition, since the cursor displayed on the operation system interface is removed, thus terminating the proceeding of the eyeball-searching process used to determine a gaze point on which the user's eyeballs focus over the operation system interface according to the terminating command doe not interfere in the other processes, e.g. the process for displaying other information on the lenses of the wearable smart glasses user. As a result the user can still read the information displayed on the lenses of the wearable smart glasses user.

From the forgoing, by receiving the controlling command provided by the user through the touch switch module, a corresponding process can be performed at the gaze point on which the user's eyeballs focus over the operation system interface, thereby the wearable smart glasses can be well operated by a user's touch gesture, even if the wearable smart glasses is operated in a context that an audio controlling command with clear articulation and a mellow and full tone is not available. As a result, the operating reliability and efficiency of the wearable smart glasses can be improved significantly, so as to provide more convenience to the user.

### Third Embodiment

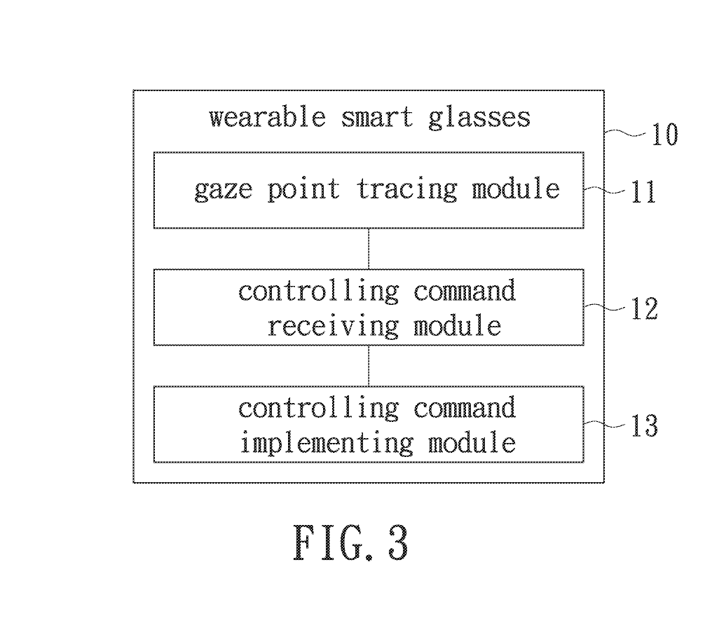

FIG. 3 is a block diagram illustrating a device for controlling a wearable smart glasses, in accordance with a third embodiment of the present invention, wherein the wearable smart glasses 10 can be applied to implement the method disclosed in the first embodiment. As shown in FIG. 3, the device for controlling a wearable smart glasses 10 comprises a gaze point tracing module 11, a controlling command receiving module 12 and a controlling command implementing module 13.

The gaze point tracing module 11 is used to determine and trace a gaze point on which a user's eyeballs focus over an operation system interface of the wearable smart glasses.

The controlling command receiving module 12 is used to receive the controlling command provided by the user trough a touch switch module.

The controlling command implementing module 13 is used to perform a corresponding process at the gaze point according to the controlling command received by the controlling command receiving module 12.

Since the steps and mechanism of the various modules of the wearable smart glasses 10 that is applied to implement the method for controlling the wearable smart glasses 10 has been clearly described in FIGS. 1 and 2A-2C and the pertinent description thereof, thus the detailed step mechanism thereof will not be redundantly described herein again.

From the forgoing, by receiving the controlling command provided by the user through the touch switch module, a corresponding process can be performed at the gaze point on which the user's eyeballs focus over the operation system interface, thereby the wearable smart glasses can be well operated by a user's touch gesture, even if the wearable smart glasses is operated in a context that an audio controlling command with clear articulation and a mellow and full tone is not available. As a result, the operating reliability and efficiency of the wearable smart glasses can be improved significantly, so as to provide more convenience to the user.

### Fourth Embodiment

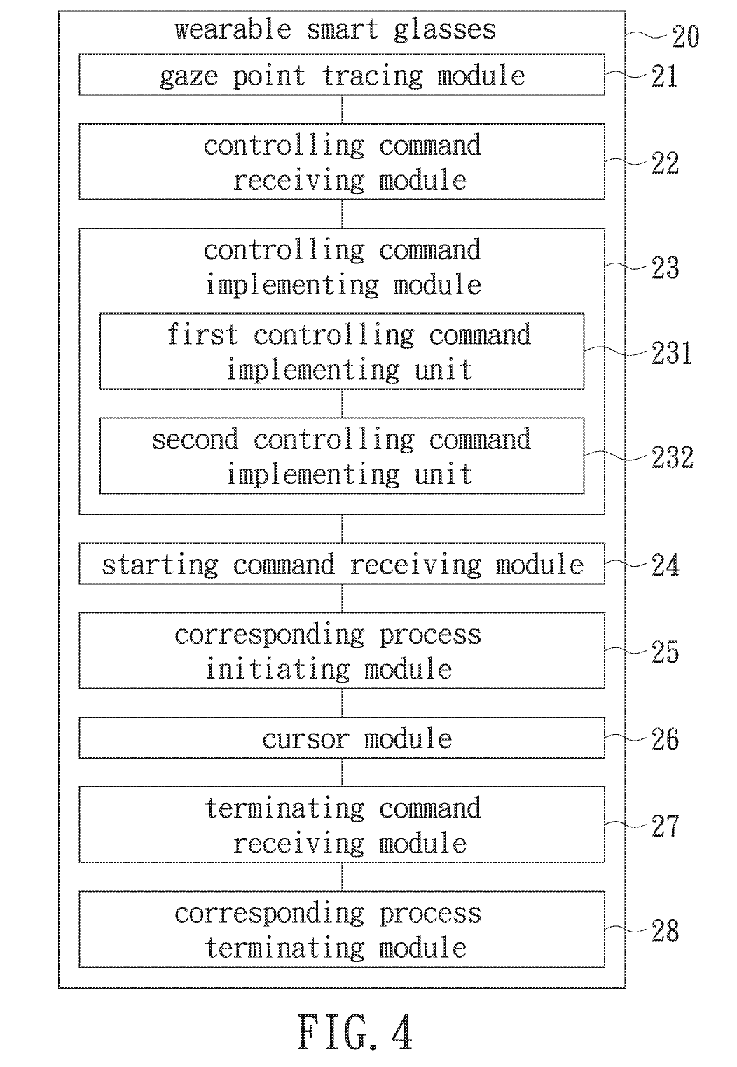

FIG. 4 is a block diagram illustrating a device for controlling a wearable smart glasses, in accordance with a fourth embodiment of the present invention, wherein the wearable smart glasses 20 can be applied to implement the method disclosed in the second embodiment. As shown in FIG. 4, the wearable smart glasses 20 comprises a gaze point tracing module 21, a controlling command receiving module 22, a controlling command implementing module 23, a starting command receiving module 24, a corresponding process initiating module 25, a cursor module 26, a terminating command receiving module 27 and a corresponding process terminating module 28.

The gaze point tracing module 21 is used to determine and trace a gaze point on which a user's eyeballs focus over an operation system interface of the wearable smart glasses.

The controlling command receiving module 22 is used to receive the controlling command provided by the user trough a touch switch module.

The controlling command implementing module 23 is used to perform a corresponding process at the gaze point according to the controlling command received by the controlling command receiving module 22. The controlling command implementing module 23 comprises a first controlling command implementing unit 231 and a second controlling command implementing unit 232. When the controlling command received by the controlling command receiving module 22 is an audio controlling command, the first controlling command implementing unit 231 performs a corresponding process at the gaze point according to the audio controlling command; and otherwise when the controlling command received by the controlling command receiving module 22 is a touch gesture controlling command, the second controlling command implementing unit 232 performs a corresponding process at the gaze point according to the touch gesture controlling command.

The starting command receiving module 24 is used to receiving a starting command provided by the user.

The corresponding process initiating module 25 is used to starting the an eyeball-searching process used to determine a gaze point on which the user's eyeballs focus over an operation system interface is started according to the starting command received by the starting command receiving module 24.

The cursor module 26 is used to create a cursor and display the cursor on the gaze point, so as to inform the user the position of the gaze point being over the operation system interface.

The terminating command receiving module 27 is used to receive a terminating command provided by the user.

The corresponding process terminating module 28 is used to terminate the eyeball-searching process used to determine the gaze point on which the user's eyeballs focus over the operation system interface and remove the cursor.

Preferably, in some embodiments, the controlling commands preferably may be an audio controlling command provided by voice input or/and a touch gesture controlling command resulted from the user's touch gesture detected and converted by a touch switch module of the wearable smart glasses.

Since the functions and mechanism of the wearable smart glasses 20 applied to implement the method disclosed in the second embodiment has been clearly described in FIGS. 1 and 2A-2C and the pertinent description thereof, and thus will not be redundantly described herein again.

The wearable smart glasses 20 provided by the present embodiment can be use to receive the controlling command provided by the user through the touch switch module, to perform a corresponding process at the gaze point on which the user's eyeballs focus over the operation system interface, thereby the wearable smart glasses can be well operated by a user's touch gesture, even if the wearable smart glasses is operated in a context that an audio controlling command with clear articulation and a mellow and full tone is not available. As a result, the operating reliability and efficiency of the wearable smart glasses can be improved significantly, so as to provide more convenience to the user.

### Fifth Embodiment

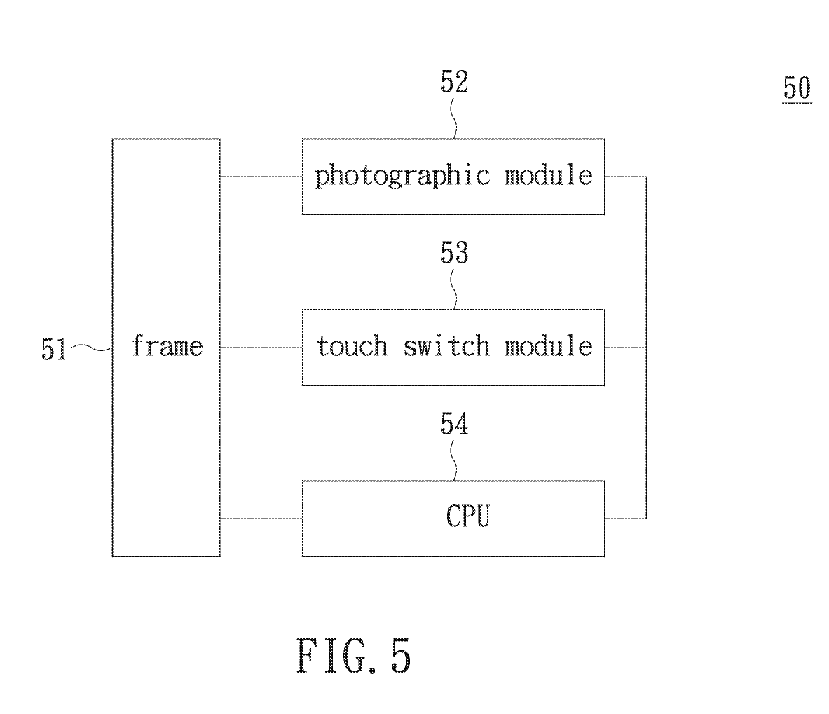

FIG. 5 is a block diagram illustrating a device for controlling a wearable smart glasses, in accordance with a fifth embodiment of the present invention. In the present embodiment, the wearable smart glasses 50 comprises a frame 51, a photographic module 52, a touch switch module 53 and a CPU 54.

The photographic module 52 is used to determine and trace a gaze point over an operation system interface of the wearable smart glasses 50 on which a user's eyeballs focus.

The touch switch module 53 is disposed on the frame 51 and used to receive a touch gesture controlling command provided by a user's touch gesture. In the present embodiment, the touch switch module 53 can either receive a touch gesture controlling command that is initiated by the user in a manner of touching a control button set on the frame 51 of the wearable smart glasses 50 or receive a touch gesture controlling command that is initiated by a user's touch gesture detected on a touch panel set on a surface of the frame 51.

The CPU 54 is used to perform a corresponding process on the gaze point according to the touch gesture controlling command.

The wearable smart glasses 50 preferably comprises two lenses used to display the operation system interface of the wearable smart glasses 50.

The wearable smart glasses 50 preferably further comprises an image projection module used to project the operation system interface in the user's filed of vision.

The wearable smart glasses 50 preferably further comprises a switch module that is disposed on the frame 51 and used to receive a starting command or a terminating command provided by the user.

In some embodiments, the wearable smart glasses 50 preferably can be connected to an external device, such as a control wire, used to receive a starting command or a terminating command provided by the user.

The wearable smart glasses 50 preferably further comprises a microphone used to receive user's audio voice via a voice input; and the user's audio voice is subsequently converted into an audio controlling command.

The CPU 54 can used to perform a corresponding process on the gaze point according to the audio controlling command or the touch gesture controlling command.

Since the functions and mechanism of the wearable smart glasses 50 applied to implement the method disclosed in the aforementioned embodiments has been clearly described in FIGS. 1 and 2 and the pertinent description thereof, similar devices, apparatus and applications can be further referenced to FIGS. 3 and 4 and the pertinent description thereof, and thus will not be redundantly described herein again.

It should be appreciated that each of the aforementioned embodiments can make cross reference to one another; nevertheless they are described in a manner of going forward one by one. In other words, although each of the aforementioned embodiments may disclose some features different from one another, a cross reference can be still made between the similar portions of these different embodiments. Since the functions and mechanism of the wearable smart glasses and the device for controlling the same has been clearly described in those embodiments that describe the method to which the wearable smart glasses and the device apply, thus the description about the functions and mechanism of the wearable smart glasses and the controlling device may be redundantly described again in the pertinent embodiments. However, a cross reference can be still made there between.

In the detailed description, the phrases “the first” and “the second” are just used to distinguish one element from another. It does not imply that there is any correlation or priority existing between these two elements. The phrases of “comprise”, “include” and the similar phrases may be interpreted as to encompassing all the elements listed, but may also including additional, unnamed elements. Thus if a processes, a method, an article or an apparatus is described as to “comprising” or “including” some elements, it means that the processes, the method, the article or the apparatus may encompass all the elements listed, but may also include additional, unnamed elements.

Besides, a person skilled in the art would recognize that the method and process disclosed within the aforementioned embodiments can be, either entirely or partially, implemented by hardware controlled by a program stored in a medium, wherein the medium may be a read-only memory (ROM), a disk memory, or a compact disk.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for controlling a wearable smart glasses comprising:
determining and tracing a gaze point over an operation system interface on which a user's eyeballs focus;
receiving a controlling command provided by the user through a touch switch module; and
performing a corresponding process on the gaze point according to the controlling command.

2. The method according to claim 1, prior to the step of determining and tracing the gaze point over the operation system interface, further comprising:
receiving a starting command provided by the user; and
starting the step of determining and tracing the gaze point over the operation system interface according to the starting command.

3. The method according to claim 1, after the step of determining and tracing the gaze point over the operation system interface, further comprising:
creating a cursor; and
displaying the cursor on the gaze point, so as to inform the user the position of the gaze point being over the operation system interface.

4. The method according to claim 3, further comprising:
receiving a terminating command provided by the user; and
terminating the step of determining and tracing the gaze point over the operation system interface according to the terminating command.

5. The method according to claim 4, wherein the controlling command comprises an audio controlling command provided by a voice input, a touch gesture controlling command resulted from a touch gesture detected and converted by a touch switch module, or a combination of the audio controlling command and the touch gesture controlling command.

6. The method according to claim 3, wherein the controlling command comprises an audio controlling command provided by a voice input, a touch gesture controlling command resulted from a touch gesture detected and converted by a touch switch module, or a combination of the audio controlling command and the touch gesture controlling command.

7. The method according to claim 2, wherein the controlling command comprises an audio controlling command provided by a voice input, a touch gesture controlling command resulted from a touch gesture detected and converted by a touch switch module, or a combination of the audio controlling command and the touch gesture controlling command.

8. The method according to claim 1, wherein the controlling command comprises an audio controlling command provided by a voice input, a touch gesture controlling command resulted from a touch gesture detected and converted by a touch switch module, or a combination of the audio controlling command and the touch gesture controlling command.

9. The method according to claim 5, wherein the step of performing a corresponding process on the gaze point according to the controlling command comprises:
if the controlling command is the audio controlling command, performing the corresponding process on the gaze point according to the audio controlling command; and
if the controlling command is the touch gesture controlling command, performing the corresponding process on the gaze point according to the touch gesture controlling command.

10. A device for controlling a wearable smart glasses comprising:
a gaze point tracing module used to determine and trace a gaze point over an operation system interface on which a user's eyeballs focus;
a controlling command receiving module used to receive a controlling command provided by the user through a touch switch module; and
a controlling command implementing module used to perform a corresponding process at the gaze point according to the controlling command.

11. The device according to claim 10, further comprising:
a starting command receiving module used to receiving a starting command provided by the user; and
a corresponding process initiating module used to starting a step of determining and tracing the gaze point over the operation system interface according to the starting command received by the starting command receiving module.

12. The device according to claim 11, further comprising a cursor module used to create a cursor and display the cursor on the gaze point, so as to inform the user the position of the gaze point being over the operation system interface.

13. The device according to claim 12, further comprising:
a terminating command receiving module used to receive a terminating command provided by the user; and
a corresponding process terminating module used to terminate the step of determining and tracing the gaze point over the operation system interface and remove the cursor.

14. The device according to claims 10, wherein the controlling command comprises an audio controlling command provided by a voice input, a touch gesture controlling command resulted from a touch gesture detected and converted by a touch switch module, or a combination of the audio controlling command and the touch gesture controlling command.

15. The device according to claim 14, wherein the controlling command implementing module comprises:
a first controlling command implementing unit, used to perform the corresponding process at the gaze point when the controlling command received by the controlling command receiving module is an audio controlling command; and
a second controlling command implementing unit, used to perform the corresponding process at the gaze point when the controlling command received by the controlling command receiving module is a touch gesture controlling command

16. The device according to claims 11, wherein the controlling command comprises an audio controlling command provided by a voice input, a touch gesture controlling command resulted from a touch gesture detected and converted by a touch switch module, or a combination of the audio controlling command and the touch gesture controlling command.

17. The device according to claims 12, wherein the controlling command comprises an audio controlling command provided by a voice input, a touch gesture controlling command resulted from a touch gesture detected and converted by a touch switch module, or a combination of the audio controlling command and the touch gesture controlling command.

18. The device according to claims 13, wherein the controlling command comprises an audio controlling command provided by a voice input, a touch gesture controlling command resulted from a touch gesture detected and converted by a touch switch module, or a combination of the audio controlling command and the touch gesture controlling command.

19. A wearable smart glasses comprising:
a frame;
a photographic module, used to determine and trace a gaze point over an operation system interface on which a user's eyeballs focus;
a touch switch module, disposed on the frame and used to receive a controlling command converted from a user's touch gesture; and
a central processing unit (CPU) used to perform a corresponding process on the gaze point according to the controlling command.
